(19) United States
(12) Patent Application Publication
(10) Pub. No.: US 2009/0213460 A1
(43) Pub. Date: Aug. 27, 2009

(54) LIGHT DIFFUSION FILM

(75) Inventors: Hideyuki YONEZAWA, Osaka (JP); Minoru MIYATAKE, Osaka (JP); Akinori NISHIMURA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 12/389,726

(22) Filed: Feb. 20, 2009

(30) Foreign Application Priority Data
Feb. 22, 2008 (JP) 2008-40772

(51) Int. Cl. G02B 5/30

(52) U.S. Cl. 359/500

(57) ABSTRACT

A light diffusion film 20 having a wide diffusion range of light can be obtained by using 1) fibers 21 having a large refractive index difference from a transparent resin 22, and/or 2) fibers 21 which comprise two kinds of birefringent regions 21A and 21B wherein one birefringent region is included inside of the other birefringent region.

### BACKGROUND OF THE INVENTION

1. Field of the Invention

The present invention relates to a light diffusion film in which a plurality of birefringent fibers arranged on a plane surface parallel to each other are embedded in a resin.

2. Description of Related Art

Light diffusion films are used for various displays for the purpose of making light intensity distribution of light from a light source uniform and avoiding unevenness in brightness of screens. Conventionally, a film in which a plurality of birefringent fibers arranged on a plane surface parallel to each other are embedded in a resin is known as a light diffusion film (JP 2003-302507 A & Polymer Preprints, Japan Vol. 56, No. 2 (2007)). However, conventional light diffusion films had a problem of a narrow diffusion range of light that has been emitted forward. Thus, light diffusion films capable of diffusing light forward in a wide range have been demanded.

Since the conventional light diffusion films have a narrow diffusion range of light that has been emitted forward, it is an object of the present invention to provide a light diffusion film capable of diffusing light forward in a wide range.

### SUMMARY OF THE INVENTION

It has revealed that as a result of studies of inventors of the present invention, a light diffusion film having a wide diffusion range can be obtained by using 1) fibers having a large refractive index difference from a transparent resin and/or 2) fibers having two kinds of birefringent regions.

In a first preferred embodiment, a light diffusion film according to the present invention comprises: a plurality of columnar fibers arranged substantially parallel to each other; and an optically isotropic transparent resin for bonding the fibers, wherein the fibers comprise a first birefringent region in which the fibers extend in a major axis direction, and a second birefringent region included inside of the first birefringent region, and wherein an absolute value |n2−n0| of the difference between a refractive index n2 in a major axis direction of the second birefringent region and a refractive index n0 of the transparent resin is 0.03 or more.

In a second preferred embodiment of the light diffusion film according to the present invention, the size of a cross section perpendicular to the major axis direction of the second birefringent region is 0.5 μm to 10 μm.

In a third preferred embodiment of the light diffusion film according to the present invention, a plurality of the second birefringent regions are included inside of the first birefringent region.

In a fourth preferred embodiment of the light diffusion film according to the present invention, a refractive index n0 of the transparent resin, a refractive index n1 in the major axis direction of the first birefringent region, and a refractive index n2 in the major axis direction of the second birefringent region meet the relationship of n0<n1<n2 or n2<n1<n0.

In a fifth preferred embodiment of the light diffusion film according to the present invention, the first birefringent region is composed of olefin-base polymer and the second birefringent regions are composed of vinyl alcohol-base polymer.

In a sixth preferred embodiment of the light diffusion film according to the present invention, the transparent region is an ultraviolet curable resin.

### ADVANTAGE OF THE INVENTION

The present invention provides a light diffusion film having a wide diffusion range of light that has been emitted forward.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic view of a conventional light diffusion film.

FIG. 2 is a schematic view of a light diffusion film of the present invention.

FIGS. 3 (a) and 3 (b) are respectively a schematic view of fibers used in the present invention.

FIG. 4 is a graph showing refractive index differences and a diffusion range of light according to Examples 1 to 3 and Comparative Examples 1 to 2.

FIG. 5 is a block diagram of a measuring system of a diffusion range of light.

### DESCRIPTION OF THE PREFERRED EMBODIMENTS

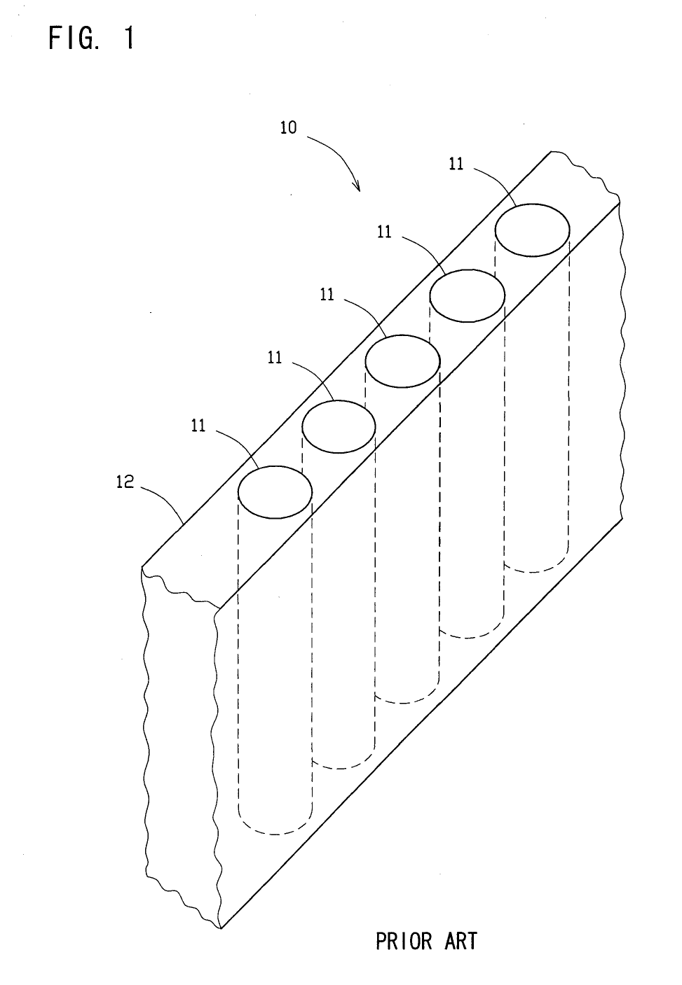

The preferred embodiments of the present invention will now be described with reference to FIGS. 1-5 of the drawings. Identical elements in the various figures are designated with the same reference numerals.

As a result of a careful study conducted by the inventors of the present invention to resolve the above-mentioned problems, it has revealed that a light diffusion film having a wide diffusion range of light can be obtained by using 1) fibers having a large refractive index difference from a transparent resin and/or 2) fibers having two kinds of birefringent regions.

When light enters into fibers from the transparent resin or when light is emitted from fibers to the transparent resin, light is refracted at the interface between the fibers and the transparent resin, so that the larger a refractive index difference Δn between the fibers and the transparent resin becomes, the larger a refractive angle becomes. Variation from an incident direction becomes significant when the reflected angle is large, resulting in a wide diffusion range of light. Accordingly it is possible to extend the diffusion range when the refractive index difference Δn between the fibers and the transparent resin is large.

When fibers having two kinds of birefringent regions are used, the same effects have been given as those when the thickness of fibers in the second birefringent region located in the fibers is thinner, even if the thickness of the fibers is as thick as conventional one. Accordingly, it is possible to extend the diffusion range, even if the fibers are as thick as the conventional fibers. It is not practical to produce a light diffusion film using extremely thin fibers due to difficulty and low productivity. On the other hand, when using fibers having two kinds of birefringent regions like the present invention, a light diffusion film having a wide diffusion range of light can be effectively produced without the use of extremely thin fibers.

### (Light Diffusion Film)

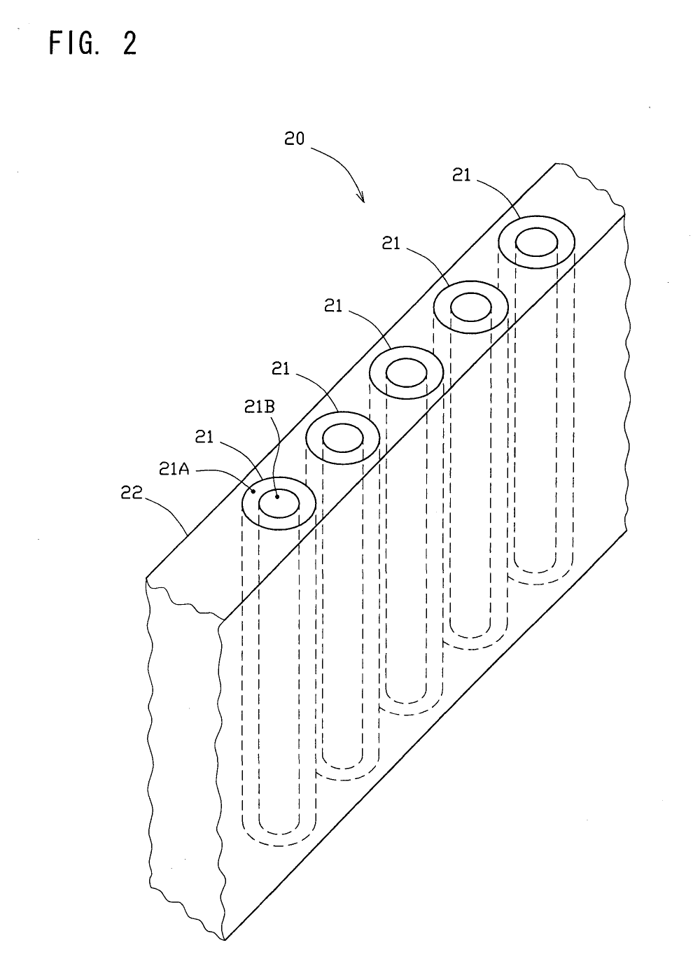

Referring to FIGS. 1 and 2, the structure of a conventional light diffusion film and a light diffusion film of the present invention will now be described. FIG. 1 is a schematic view of an example of a conventional light diffusion film 10. A plurality of columnar birefringent fibers 11 arranged on a plane surface parallel to each other are embedded in an optically isotropic transparent resin 12. The fibers 11 respectively have no particular internal structure. FIG. 2 is a schematic view of an example of a light diffusion film 20 of the present invention. A plurality of columnar fibers 21 arranged on a plane surface parallel to each other are embedded in an optically isotropic transparent resin 22. Further, fibers 21 respectively comprise: a first birefringent region 21A extending in the major axis direction of a fiber 21; and a second birefringent region 21B extending in the major axis direction composed of a material different from the first birefringent region 21A. The second birefringent region 21B is located in the first birefringent region 21A. An absolute value |n2−n0| of the difference between a refractive index n2 in the major axis direction of the second birefringent region 21B and a refractive index n0 of the transparent resin 22 is 0.03 or more. Such a light diffusion film exhibits unitary directional diffusion characteristics in which light is more easily diffused in a minor direction of the fibers compared with in the major axis direction of the fibers. Moreover, the light diffusion film has characteristics of having a wide diffusion range of light that has diffused in the minor axis direction of the fibers. The light diffusion film of the present invention preferably has a thickness of 5 μm to 200 μm.

The term “substantially parallel” used herein means that an inclination against a truly parallel reference direction is three-dimensionally within ±20 degrees, more preferably within ±10 degrees. Even if the fibers 21 are not exactly arranged parallel to each other, the effects of the present invention can be obtained sufficiently if only the fibers are substantially in a state of parallel.

### (Fibers)

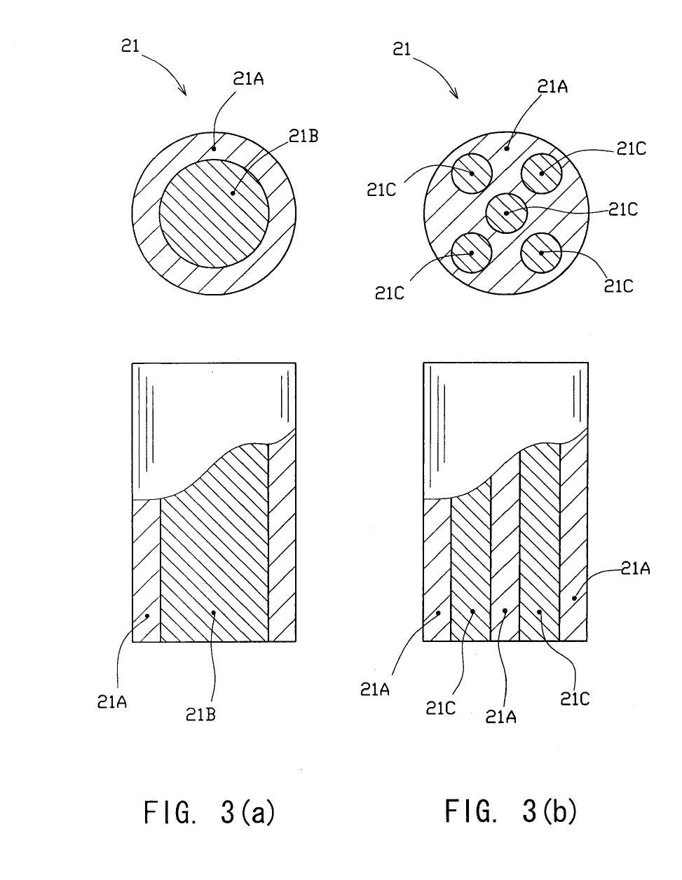

Any fibers may be used in the present invention, if only the fibers comprise two kind of birefringent regions extending in the major axis direction wherein the second birefringent region is located in the first birefringent region. The aforementioned fibers preferably have translucency and are more preferably colorless and translucent. For instance, FIG. 3 (a) shows a core-in-sheath structure wherein the single second birefringent region 21B is located in the first birefringent region 21A. FIG. 3 (b) shows a sea-island structure or the like wherein a plurality of second birefringent regions 21C are located in the first birefringent region 21A. The diameter of the fibers 21 is preferably 2 μm to 50 μm, more preferably 2 μm to 30 μm.

While FIGS. 3 (a) and 3 (b) respectively show that a fiber 21 consists of the first birefringent region 21A and the second birefringent regions 21B and 21C, the fiber used in the present invention may comprise a third birefringent region not shown in the figures or an optical isotropic region. In FIG. 3 (b), the second birefringent regions 21C are in the shape of a column, however, the second birefringent regions 21C may be any polygonal column-shaped, such as triangle column-shaped, quadratic column-shaped, and column-shaped having smooth angles or the like. Further, the second birefringent regions do not need to be uniformly dispersed in the first birefringent region but may be eccentrically-located.

The fibers used in the present invention are preferably sea-island structures shown in FIG. 3 (b). Compared with the core-in-sheath structure, in a sea-island structure, the cross section area of the second birefringent region becomes smaller and in addition to that, diffusion points of light are increased, which leads to an increase in opportunities of refract a number of times in one fiber. As a result, it is possible to obtain a light diffusion film capable of emitting incident light while diffusing the incident light in a wider range ahead.

In the case of the sea-island structure shown in FIG. 3 (b), the cross section of an island portion (the second birefringent region 21C) is preferably 0.5 μm to 10 μm, more preferably 0.5 μm to 5 μm, furthermore preferably 0.5 μm to 2 μm. Wavelength dependence of diffusion light intensity could arise in a visible light region (wavelength 380 nm to 780 nm) when the cross section of the island portion is too small, which may color the light diffusion film. Forming the second birefringent region with this size of the cross section inside the first birefringent region makes it possible to effectively produce a light diffusion film having a wide diffusion range of light without the use of extremely thin fibers that are difficult in production and handling.

The term “the size of the cross section of the second birefringent region” used herein means its diameter when the second birefringent region observed on the cross section perpendicular to the axis of the fibers is circular and the maximum diameter of its shape when the second birefringent region is not circular.

In the light diffusion film of the present invention, it is preferable that the refractive index n0 of the transparent resin, the refractive index n1 in the major axis direction of the first birefringent region, and the refractive index n2 in the major axis direction of the second birefringent region satisfy the relationship of n0<n1<n2 or n2<n1<n0. As has been described above, in the light diffusion film wherein refractive indices gradate, a refractive index difference becomes smaller at an interface of each member, so that interface reflection occurring at the interface between the transparent resin and the fibers can be reduced, resulting in smaller back scattering.

To obtain a wide diffusion range of light, the absolute value |n2−n0| of the difference between the refractive index n2 in the major axis direction of the second birefringent region and the refractive index n0 of the transparent resin is preferably 0.03 or more and more preferably 0.04 or more to further extend the diffusion range of light. The aforementioned refractive index difference |n2−n0| is preferably 0.20 or less in a viewpoint of a balance with back scattering and more preferably 0.15 or less. It is possible to increase or decrease the above-mentioned birefringent indices and the refractive index difference by selecting the kinds of materials and manufacturing conditions of fibers (for instance, stretching magnification) as appropriate.

In the light diffusion film of the present invention, the absolute value of the difference between the refractive index n0 of the transparent resin and the refractive index n2′ in the minor axis direction of the second birefringent region is preferably |n2′−n0|≦0.06. The light diffusion film that satisfies this relationship may be used as a scattered polarizer to scatter one polarizing component so that another polarizing component may be permeated when dividing incident light into two polarizing components that are mutually perpendicular.

### (Birefringent Region)

The term “birefringent region” used herein means a region wherein the difference (birefringent index Δn=n−n′) between a refractive index n in the major axis direction of the fibers and a refractive index n′ in the minor axis direction of the fibers is 0.001 or more.

The first birefringent region and the second birefringent region composed of fibers used in the present invention are formed by any material excellent in transparency and exhibiting birefringence. The fibers used in the present invention preferably comprise at least two kinds of polymer materials. Examples of the materials forming the first and second birefringent regions include olefin-base polymer, vinyl alcohol-base polymer, (metha) acryl-base polymer, ester-base polymer, stylene-base polymer, imido-base polymer, amide-base polymer, liquid crystal polymer or the like and blended polymer of these polymers. A preferable combination of materials for forming the first birefringent region and the second birefringent region is that the first birefringent region is olefin-base polymer and the second birefringent region is vinyl alcohol-base polymer. Such combination makes it possible to obtain large birefringence because of excellent stretching properties. Further, excellent adhesion of the first birefringent region and the second birefringent region makes it possible to prevent a clearance (air layer) at the interface of each region, which leads to obtain excellent diffusion characteristics.

Examples of the above-mentioned olefin-base polymer include polyethylene, polypropylene, ethylene propylene copolymer and their blended polymer or the like. Examples of the above-mentioned vinyl alcohol-base polymer include polyvinyl alcohol, ethylene vinyl alcohol copolymer, and their blended polymer or the like.

A birefringent index Δn1 of the first birefringent region (the difference between the refractive index n1 in the major axis direction and the refractive index n1′ in the minor axis direction: n1−n1′) is preferably 0.001 to 0.20, more preferably 0.001 to 0.10. A birefringent index Δn2 of the second birefringent region (the difference between the refractive index n2 in the major axis direction and the refractive index n2′ in the minor axis direction: n2−n2′) is preferably 0.01 to 0.30, more preferably 0.02 to 0.20. The light diffusion film wherein each birefringent region shows the above-mentioned birefringent value exhibits good diffusion properties.

### (Transparent Resin)

The term “transparent resin” used herein means a transparent resin having a transmittance of 80% or higher at a wavelength of 546 nm. The transparent resin used in the present invention preferably combines the fibers and is formed by any materials excellent in transparency. Examples of the material of the transparent resin used in the present invention include an ultraviolet curable resin, cellulose-base polymer, norbornene-base polymer or the like. An energy curable resin is preferable as a transparent resin, more specifically, an ultraviolet curable resin is especially preferable. The ultraviolet curable resin has high productivity because the ultraviolet curable resin can form films at high speed.

The refractive index n0 of the transparent resin is preferably 1.3 to 1.7, more preferably 1.4 to 1.6. It is possible to increase or decrease the refractive index n0 of the transparent resin as appropriate by changing the kinds of organic groups to be introduced into resin and/or the content. For instance, it is possible to increase the refractive index of the transparent resin by introducing a cyclic aromatic group (phenyl group or the like) into the transparent resin. On the other hand, it is possible to decrease the refractive index of the transparent resin by introducing an aliphatic system group (methyl group or the like) into the transparent resin.

The transparent resin used in the present invention is preferably an optically isotropic resin with small refractive index anisotropy. The term “optically isotropic” used herein means that the birefringent index (the difference between the refractive index in the maximum direction and the refractive index in the minimum direction) is less than 0.001.

The transparent resin may bind fibers each other. While it is preferable that the fibers are fully embedded in the transparent resin, the fibers may be insufficiently embedded in the transparent resin where fibers may be partially exposed. The amount of the transparent resin used is preferably 10 weight parts to 500 weight parts with reference to 100 weigh parts of fibers.

### (Manufacturing Method)

Typically, the light diffusion film of the present invention can be obtained by arranging a plurality of fibers on one plane surface substantially parallel to each other and applying a solvent for forming a transparent resin on the surface of the fiber to solidify or harden applied layers so that the fibers can be fixed.

For instance, the fibers having the first and second birefringent regions can be prepared by stretching a spinning filament including two different kinds of materials. Such a spinning filament can be prepared by melting at least two kinds of polymer materials to be expelled from a spinning nozzle. Alternatively, the spinning filament can be prepared by coating other material on a surface of a unitary structured spinning filament.

While methods for arranging a plurality of fibers parallel to each other are not particularly limited, for instance, an ordinary manufacturing method for non-woven fabric may be applied. Specifically, examples of the methods include a dry method for making short fibers to be in the form of a sheet with a spinning guard, a spunbonding method for accumulating long fibers obtained from a spinning nozzle, and a wet method for making extremely short fibers in the form of a sheet by dispersing the extremely short fibers into water after passing a papermaking process or the like.

Example of methods for fixing a plurality of fibers include a method for solidifying a resin by applying the resin dissolved in a solvent onto the surfaces of a plurality of fibers to be dried under the conditions of the solvent vaporizes and a method for curing the resin by applying an ultraviolet curable resin on the surfaces of a plurality of fibers to irradiate ultraviolet rays.

### (Usage of Light Diffusion Film)

Light diffusion films of the present invention are for example, used for liquid crystal panels for computers, copy machines, cell phones, watches, digital cameras, Personal Digital Assistance, portable game devices, video cameras, televisions, electronics ovens, car navigation systems, car audio videos, store monitors, supervisory monitors, and monitors for medical purposes or the like.

### EXAMPLES

### Example 1

An ethylene vinyl alcohol copolymer (produced by Nippon Synthetic Chemical Industry Co., Ltd. Product Name: “Soarnol DC321B,” melting point: 181° C.) and an ethylene propylene copolymer of excessive propylene (produced by Japan Polypropylene Corporation, Product Name “OX1066A”, melting point: 138° C.) were respectively fused at 270° C. and 230° C. and then were charged into a nozzle for sea-island composite fiber spinning (island number per fiber cross section: 37) to obtain a spinning filament with a diameter of 30 μm by spinning these copolymers at a pulling rate of 600 m/minute.

This spinning filament was stretched 4 times as long as the original length in warm water at 60° C. to obtain fibers with a diameter of 15 μm. When the cross section surfaces of the fibers were observed with an electron microscope, it was confirmed that a sea-island structure was configured wherein a columnar (diameter of its cross section: approximately 1 μm) second birefringent region (island portion) composed of an ethylene vinyl alcohol copolymer was distributed inside a columnar (diameter of its cross section: 15 μm) first birefringent region (sea portion) composed of an ethylene propylene copolymer.

A number of the above-mentioned fibers were prepared. And then the fibers were arranged so that the major direction of the fibers might be parallel to one another on a surface of a polyethylene terephthalate film (thickness: 38 μm) on which a polyethylene acrylate-base ultraviolet curable resin (produced by Sartomer Company Inc., Product Name: “CN2270”) was applied as an optically isotropic transparent resin so that the fibers might be embedded therein. Subsequently, the ultraviolet transparent resin was cured by irradiating ultraviolet rays (illuminance=40 mW/cm², amount of integrating light: 1,000 mJ/cm²) and then the polyethylene terephthalate film was peeled off to prepare a light diffusion film with a thickness of 150 μm. The used amount of the ultraviolet curable resin was 100 weight parts with respect to 100 weight parts of the fibers.

In the light diffusion film prepared in such a manner, when parallel (collimated) light entered, large diffusion light was emitted in a minor axis direction of the fibers, so that the light diffusion film had unitary directional diffusion characteristics that diffusion light was hardly emitted in the major axis direction of the fibers. Refractive indices of components of the light diffusion film were as shown in Table 1. The diffusion range of outgoing light was as shown in Table 2.

### Example 2

A light diffusion film with a thickness of 150 μm was prepared in the same manner as in Example 1 except for using a polyester acrylate-base ultraviolet curable resin (produced by Sartomer Company, Inc., Product Name: “CN2302”) as an optically isotropic transparent resin. Refractive indices of components of the light diffusion film were as shown in Table 1. And the diffusion range of outgoing light was as shown in Table 2.

### Example 3

A light diffusion film with a thickness of 150 μm was prepared in the same manner as in Example 1 except for using a cyclic acrylate-base ultraviolet curable resin (produced by Sartomer Company, Inc., Product Name: “SR833”) as an optically isotropic transparent resin. Refractive indices of components of the light diffusion film were as shown in Table 1. The diffusion range of outgoing light was as shown in Table 2.

### Comparative Example 1

A spinning filament with a diameter of 26 μm was obtained in the same manner as in Example 1 except for using a norbornene-base resin (produced by Mitsui Chemicals, Inc., Product Name: “TOPAS”) instead of an ethylene propylene copolymer. Then the spinning filament was stretched 3 times as long as the original length in warm water at 60° C. to obtain fibers with a diameter of 15 μm.

When the cross section surfaces of the fibers were observed with an electron microscope, it was confirmed that a sea-island structure was configured wherein a columnar second birefringent region (island portion) composed of an ethylene vinyl alcohol copolymer was distributed inside a columnar (diameter of its cross section: 15 μm) first birefringent region (sea portion) composed of a norbornene-base resin.

A number of the above-mentioned fibers were prepared. And then the fibers were arranged so that the major direction of the fibers might be parallel to one another on a surface of a polyethylene terephthalate film (thickness: 38 μm) on which a polyethylene acrylate-base ultraviolet curable resin (produced by Sartomer Company Inc., Product Name: “CN975”) was applied as an optically isotropic transparent resin so that the fibers might be embedded therein. Subsequently, the ultraviolet transparent resin was cured by irradiating ultraviolet rays (illuminance=40 mW/cm², amount of integrating light: 1,000 mJ/cm²) and then the polyethylene terephthalate film was peeled off to prepare a light diffusion film with a thickness of 150 μm. Refractive indices of components of the light diffusion film were as shown in Table 1. The diffusion range of outgoing light was as shown in Table 2.

### Comparative Example 2

An ethylene vinyl alcohol copolymer (produced by Nippon Synthetic Chemical Industry Co., Ltd. Product Name: “Soarnol DC321B,” melting point: 181° C.) was fused at 270° C. and then was charged into a nozzle for single structure-fiber spinning to obtain a spinning filament with a diameter of 26 μm by spinning the spinning filament at a pulling rate of 600 m/minute. This spinning filament was stretched 3 times as long as the original length in warm water at 60° C. to obtain fibers with a diameter of 15 μm.

A light diffusion film with a thickness of 150 μm was prepared in the same manner as in Example 1 except for using these fibers. Refractive indices of components of the light diffusion film were as shown in Table 1. The diffusion range of outgoing light was as shown in Table 2.

TABLE 1

| | Fiber | | | | |
|---|---|---|---|---|---|
| | First birefringent region | | Second birefringent region | | |
| | Refractive | Refractive | Refractive | Refractive | |
| | index n1 in | index n1′ in | index n2 in | index n2′ in | Refractive index |
| | major axis | minor axis | major axis | minor axis | n0 of transparent |
| | direction | direction | direction | direction | resin |
| Example 1 | 1.52 | 1.49 | 1.56 | 1.52 | 1.47 |
| Example 2 | 1.52 | 1.49 | 1.56 | 1.52 | 1.50 |
| Example 3 | 1.52 | 1.49 | 1.56 | 1.52 | 1.52 |
| Comparative | 1.54 | 1.53 | 1.55 | 1.52 | 1.53 |
| Example 1 | | | | | |
| Comparative | Nil | Nil | 1.56 | 1.52 | 1.47 |
| Example 2 | | | | | |

TABLE 2

| | Refractive index | Presence of | Light diffusion film | |
|---|---|---|---|---|
| | Difference | Second bire- | Diffusion | Back |
| | \|n2 − n0\| | fringent region | range | scattering |
| Example 1 | 0.09 | Yes | ±40° | Small |
| Example 2 | 0.06 | Yes | ±20° | Small |
| Example 3 | 0.04 | Yes | ±15° | Small |
| Comparative | 0.02 | Yes | ±5° | Small |
| Example 1 | | | | |
| Comparative | *0.09 | No | ±15° | Large |
| Example 2 | | | | |

Note:
The refractive index difference in Comparative Example 2 is the difference between the refractive index in the major axis direction of fibers (single structure) and the refractive index of the transparent resin.

### (Assessment)

FIG. 4 is a graph showing a diffusion range of outgoing light in Examples 1 to 3 and Comparative Examples 1 to 2. The horizontal axis shows absolute values of the difference between the refractive index n0 of a transparent resin and the refractive index n2 in the major axis direction of the second birefringent region and the vertical axis shows a diffusion range (Unilateral values in plus side) of outgoing light. As you can see from the graph, 1) even if the size of the cross section of the second birefringent region is the same, the larger the refractive index differences |n2−n0| between the refractive index of the transparent resin and the refractive index in the major axis direction of fibers become, the wider the diffusion range becomes (Examples 1 to 3 and Comparative Example 1), and 2) even if the refractive index differences |n2−n0| are the same, the smaller the size of the cross section of the second birefringent region becomes, the wider the diffusion range becomes (Example 1 and Comparative Example 2).

### (Measuring Method)

### (Diffusion Range)

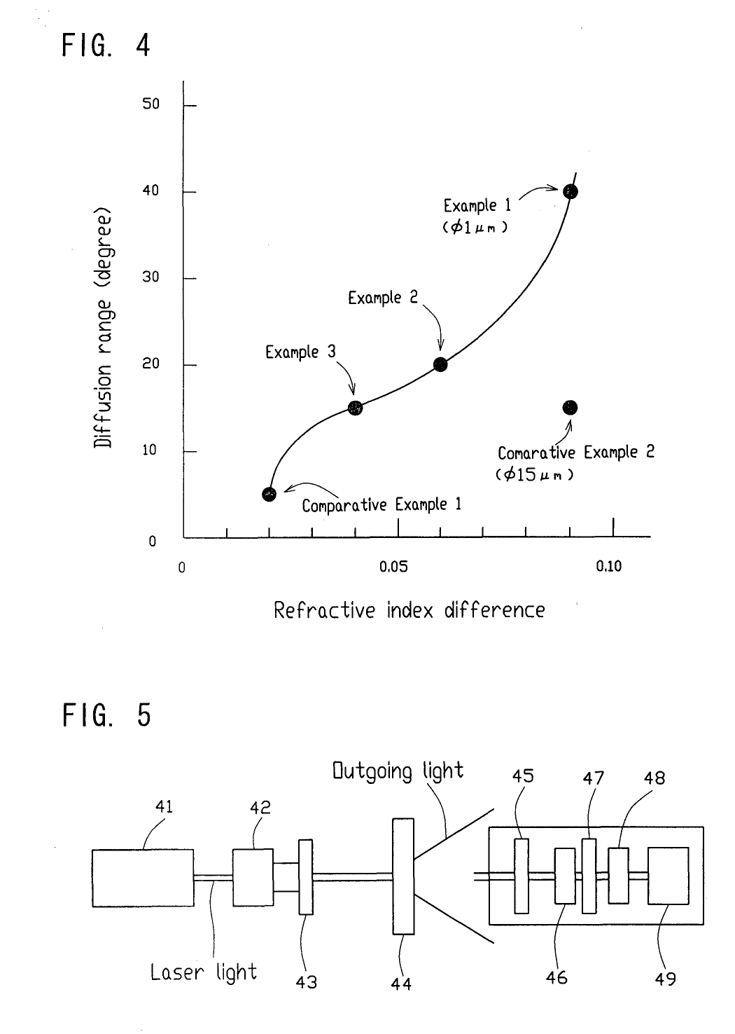

A diffusion range of light was measured with a goniophotometer produced by Sigma Koki Co., Ltd. FIG. 5 shows a schematic view of a measuring apparatus. Laser light emitted from a light source 41 (produced by SOC Corporation, Product Name: “J005GM”) with a wavelength of 532 nm was expanded by a beam expander 42 (produced by Sigma Koki Co., Ltd., Product Name: “LEBD-10”). After passing through a λ/4 plate (not shown, produced by Sigma Koki Co., Ltd., Product Name: “WPQW-VIS-4M”) and a depolarized element (not shown, produced by Sigma Koki Co., Ltd., Product Name: “DEQ-20P”), the laser light was allowed to transmit a slit 43 (produced by Sigma Koki Co., Ltd., Product Name: “IH-22R”) to obtain laser light of φ3 mm. The laser light was irradiated perpendicular to a light diffusion film 44.

Outgoing light emitted from the light diffusion film 44 was collected by a lens 46 (produced by Sigma Koki Co., Ltd., focal length f: 144.6 mm) after passing through a slit 45. The light was further collimated with a lens 48 to measure light amount by a detector 49 (produced by Hamamatsu Photonics K.K., Product Name: “S2592-03”). An optical system was designed so that visual field might be 0.5 degree. The above-mentioned laser light source 41, the light diffusion film 44, and the detector 49 were arranged on the same axis.

The light diffusion film 44 was disposed in such a manner that an average aligned direction (major axis direction) of fibers is in a perpendicular direction. Using an axis in the perpendicular direction of the detector 49 as a rotation axis, the intensity of diffusion light was measured while moving the direction of irradiated laser light by 1° up to −80° to +80° when the direction of the irradiated laser light was 0°. The diffusion range was set to a half-value angle of the maximum intensity of the diffusion light.

### (Back Scattering)

A black acrylic board was adhered to the back of a light diffusion film and a surface of the light diffusion film was illuminated by a white fluorescent lamp to visually observe the intensity of reflected light.

### (Refractive Index of Fibers)

A refractive index at room temperature (25° C.) and at the wavelengths of 546 nm was measured by the Becke's line method using a polarization microscope produced by Olympus Corporation.

### (Refractive Index of Transparent Resin)

A refractive index at room temperature (25° C.) and at the wavelengths of 546 nm was measured using a prism coupler produced by Sairon Technology Ltd.

It is to be understood that the present invention may be practiced in other embodiments in which various improvements, modifications, and variations are added on the basis of knowledge of those skilled in the art without departing from the spirit of the present invention. Further, any of the specific inventive aspects of the present invention may be replaced with other technical equivalents for embodiment of the present invention, as long as the effects and advantages intended by the invention can be insured. Alternatively, the integrally configured inventive aspects of the present invention may comprise a plurality of members and the inventive aspects that comprise a plurality of members may be practiced in a integrally configured manner.

There has thus been shown and described a novel light diffusion film which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

This application claims priority from Japanese Patent Application No. 2008-040772, which is incorporated herein by reference.

1. A light diffusion film comprising:
a plurality of columnar fibers arranged substantially parallel to each other; and
an optically isotropic transparent resin for bonding the fibers,
wherein the fibers comprise a first birefringent region in which the fibers extend in a major axis direction and a second birefringent region included inside of the first birefringent region, and wherein an absolute value |n2−n0| of the difference between a refractive index n2 in a major axis direction of the second birefringent region and a refractive index no of the transparent resin is 0.03 or more.

2. The film according to claim 1, wherein the size of the cross section of the second birefringent region perpendicular to the major axis is 0.5 μm to 10 μm.

3. The film according to claim 1, wherein a plurality of second birefringent regions are included inside of the first birefringent region.

4. The film according to claim 1, wherein the refractive index no of the transparent resin, a refractive index n1 in a major axis direction of the first birefringent region, and the refractive index n2 in the major axis direction of the second birefringent region meet the relationship of n0<n1<n2 or n2<n1<n0.

5. The film according to claim 3, wherein the refractive index n0 of the transparent resin, a refractive index n1 in a major axis direction of the first birefringent region, and the refractive index n2 in the major axis direction of the second birefringent region meet the relationship of n0<n1<n2 or n2<n1<n0.

6. The film according to claim 1, wherein the first birefringent region is composed of olefin-base polymer and the second birefringent region is composed of vinyl alcohol-base polymer.

7. The film according to claim 3, wherein the first birefringent region is composed of olefin-base polymer and the second birefringent region is composed of vinyl alcohol-base polymer.

8. The film according to claim 4, wherein the first birefringent region is composed of olefin-base polymer and the second birefringent region is composed of vinyl alcohol-base polymer.

9. The film according to claim 5, wherein the first birefringent region is composed of olefin-base polymer and the second birefringent region is composed of vinyl alcohol-base polymer.

10. The film according to claim 1, wherein the transparent resin is an ultraviolet curable resin.

11. The film according to claim 3, wherein the transparent resin is an ultraviolet curable resin.

12. The film according to claim 4, wherein the transparent resin is an ultraviolet curable resin.

13. The film according to claim 5, wherein the transparent resin is an ultraviolet curable resin.

14. The film according to claim 6, wherein the transparent resin is an ultraviolet curable resin.

15. The film according to claim 7, wherein the transparent resin is an ultraviolet curable resin.

16. The film according to claim 8, wherein the transparent resin is an ultraviolet curable resin.

17. The film according to claim 9, wherein the transparent resin is an ultraviolet curable resin.
